(19) United States
(12) Patent Application Publication
(10) Pub. No.: US 2023/0027597 A1
(43) Pub. Date: Jan. 26, 2023

(54) ANODE FOR LITHIUM SECONDARY BATTERY INCLUDING STABLE SOLID ELECTROLYTE INTERPHASE LAYER AND ELECTROLYTE COMPOSITION FOR MANUFACTURING SAME

(71) Applicants: HYUNDAI MOTOR COMPANY, Seoul (KR); Kia Corporation, Seoul (KR); ULSAN NATIONAL INSTITUTE OF SCIENCE AND TECHNOLOGY, Ulsan (KR)

(72) Inventors: Ji Yong LEE, Goyang-si (KR); Jong Chan SONG, Suwon-si (KR); Nam Soon CHOI, Ulsan (KR); Da Young KANG, Ulsan (KR); Seung Hee HAN, Ulsan (KR); Sae Hun KIM, Ulsan (KR); Min Young LEE, Ulsan (KR)

(73) Assignees: HYUNDAI MOTOR COMPANY, Seoul (KR); Kia Corporation, Seoul (KR); ULSAN NATIONAL INSTITUTE OF SCIENCE AND TECHNOLOGY, Ulsan (KR)

(21) Appl. No.: 17/865,284

(22) Filed: Jul. 14, 2022

(30) Foreign Application Priority Data
Jul. 16, 2021 (KR) 10-2021-0093541

(51) Int. Cl. H01M 10/0567; H01M 10/0525; H01M 10/0569; H01M 10/058

(52) U.S. Cl. CPC H01M 10/0567; H01M 10/0525; H01M 10/0569; H01M 10/058; H01M 2300/0054; H01M 2300/0042

(57) ABSTRACT

An electrolyte composition for a lithium secondary battery includes a lithium salt comprising a nitrogen element, a first additive having a LUMO (lowest occupied molecular orbital) value lower than a LUMO value of the lithium salt, and a second additive having a LUMO value higher than the LUMO value of the lithium salt.

### CROSS-REFERENCE TO RELATED APPLICATION

This application claims under 35 U.S.C. § 119(a) the benefit of priority from Korean Patent Application No. 10-2021-0093541, filed on Jul. 16, 2021, the entire contents of which are incorporated herein by reference.

### TECHNICAL FIELD

The present disclosure relates to an anode for a lithium secondary battery including a stable solid electrolyte interphase layer and an electrolyte composition for manufacturing the same.

### BACKGROUND

In order to improve the energy density of a lithium secondary battery, it is necessary to increase the energy density of cathode and anode materials used in the battery. Graphite-based materials mainly used for anodes of lithium secondary batteries currently exhibit performance close to the theoretical capacity thereof, and research and development to find new anode materials capable of implementing lithium secondary batteries having improved energy density is being actively conducted.

Since lithium metal has a high capacity per unit weight and a low electrochemical potential, it is expected that the use thereof for an anode is capable of greatly increasing the energy density of a lithium secondary battery. Accordingly, a lithium metal battery using lithium metal as an anode is currently receiving attention as a next-generation battery.

Meanwhile, lithium metal has very high reactivity, so the electrolyte is reduced and decomposed to form a solid electrolyte interphase (SEI) layer on the surface of the lithium metal. Here, the formation of the SEI layer, which is non-uniform and has low ionic conductivity and mechanical strength, may cause problems such as deterioration of stability due to non-uniform plating of lithium and depletion of the electrolyte.

Therefore, the development of electrolyte materials that contribute to the formation of a stable SEI layer is a key factor in the successful development of lithium metal batteries.

### SUMMARY OF THE DISCLOSURE

An object of the present disclosure is to provide an electrolyte composition capable of forming a stable SEI layer having a multilayer structure on an anode including a lithium electrode.

The objects of the present disclosure are not limited to the foregoing. The objects of the present disclosure will be able to be clearly understood through the following description and to be realized by the means described in the claims and combinations thereof.

An embodiment of the present disclosure provides an electrolyte composition for a lithium secondary battery including a lithium salt containing a nitrogen element, a first additive having a LUMO (lowest occupied molecular orbital) value lower than the LUMO value of the lithium salt, and a second additive having a LUMO value higher than the LUMO value of the lithium salt.

The lithium salt may include a first lithium salt including at least one selected from the group consisting of lithium bis(fluorosulfonyl)imide (LiFSI), lithium bis(trifluoromethanesulfonyl)imide (LiTFSI), LiPF₆, LiBF₄, LiSbF₆, LiAsF₆, LiN(SO₂CF₃)₂, LiN(SO₃C₂F₅)₂, LiC₄F₉SO₃, LiCIO₄, LiAlO₂, LiAlCl₄, LiCl, LiI, and combinations thereof, and a second lithium salt including LiNO₃.

The concentration of the first lithium salt may range from about 0.5 mol/L to about 3 mol/L.

The concentration of the second lithium salt may range from about 0.1 mol/L to about 2 mol/L.

The LUMO value of the lithium salt may range from about −2 eV to about −1 eV.

The LUMO value of the first additive may range from about −4 eV to about −3 eV.

The first additive may include at least one selected from the group consisting of lithium bis(oxalato)borate (LiBOB), lithium difluoro bis(oxalato)phosphate (LiDFBP), lithium fluoro(oxalate)borate (LiFOB), and combinations thereof.

The amount of the first additive may range from about 0.1 wt % to about 10 wt % with respect to the electrolyte composition.

The LUMO value of the second additive may range from about −1.5 eV to about 2 eV.

The second additive may include at least one selected from the group consisting of LiPF₆, LiPO₂F₂, lithium bis(trifluoromethanesulfonyl)imide (LiTFSI), and combinations thereof.

The amount of the second additive may range from about 0.1 wt % to about 10 wt % with respect to the electrolyte composition.

The electrolyte composition may further include an organic solvent including at least one selected from the group consisting of dimethyl ether, 1,2-dimethoxyethane (DME), 1,3-dioxolane, diethylene glycol, tetraethylene glycol, diethylene glycol dimethyl ether, triethylene glycol dimethyl ether, tetraethylene glycol dimethyl ether, and combinations thereof.

Another embodiment of the present disclosure provides an anode for a lithium secondary battery including a lithium electrode, and a solid electrolyte interphase (SEI) layer disposed on the lithium electrode.

The SEI layer may include a first layer disposed on the lithium electrode and including at least one selected from the group consisting of LiF, LiₓPO_{y}F_{z} (0.1≤x≤1, 2≤y≤3, 1≤z≤2), and combinations thereof, a second layer disposed on the first layer and including Li₃N, and a third layer disposed on the second layer and including at least one selected from the group consisting of LiF, LiₓPO_{y}F_{z} (0.1, ≤x≤1, 2≤y≤3, 1≤z≤2), and combinations thereof, in which the SEI layer may be formed using the electrolyte composition described above.

Still another embodiment of the present disclosure provides a method of manufacturing a lithium secondary battery including preparing a lithium ion battery including a cathode, an anode including a lithium electrode, a separator interposed between the cathode and the anode, and the electrolyte composition described above, and forming an SEI layer on the surface of the anode by performing a formation process on the lithium ion battery, in which the SEI layer may be disposed on the anode and may include a first layer disposed on the anode and including at least one selected from the group consisting of LiF, LiₓPO_{y}F_{z} (0.1≤x≤1, 2≤y≤3, 1≤z≤2), and combinations thereof, a second layer disposed on the first layer and including Li₃N, and a third layer disposed on the second layer and including at least one selected from the group consisting of LiF, LiₓPO_{y}F_{z} (0.1≤x≤1, 2≤y≤3, 1≤z≤2), and combinations thereof.

The formation process may be performed by repeating charging and discharging 1 to 5 times under conditions of a current density of about 0.5 to about 1 mA/cm² and a capacity per unit area of about 3 to about 10 mAh/cm².

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a cross-sectional view of a lithium secondary battery according to the present disclosure;

FIG. 2 shows a cross-sectional view of an anode for a lithium secondary battery according to the present disclosure;

FIG. 3A shows the results of measurement of lithium plating/stripping reversibility in half-cell-type lithium secondary batteries according to Example 1, Comparative Example 1, and Comparative Example 2;

FIG. 3B shows an enlarged view of the results in a certain capacity range in FIG. 3A;

FIG. 4 shows the results of evaluation of the lifespan of symmetric-cell-type lithium secondary batteries according to Example 2, Comparative Example 3, and Comparative Example 4;

FIG. 5A shows the results of linear sweep voltammetry (LSV) of the electrochemical properties of the half-cell-type lithium secondary batteries according to Example 1, Comparative Example 1, and Comparative Example 2;

FIG. 5B shows an enlarged view of a portion indicated by a circle in FIG. 5A;

FIG. 6A shows the results of X-ray photoelectron spectroscopy (XPS) of the anode of the symmetric-cell-type lithium secondary battery according to Comparative Example 4;

FIG. 6B shows the results of X-ray photoelectron spectroscopy (XPS) of the anode of the symmetric-cell-type lithium secondary battery according to Comparative Example 3; and

FIG. 6C shows the results of X-ray photoelectron spectroscopy (XPS) of the anode of the symmetric-cell-type lithium secondary battery according to Example 2.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

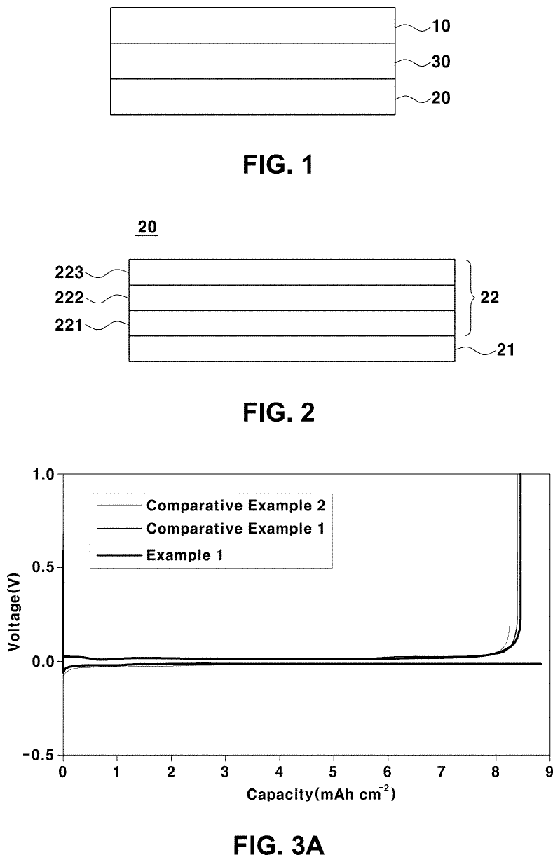

FIG. 1 shows a cross-sectional view of a lithium secondary battery according to the present disclosure. With reference thereto, the lithium secondary battery may include a cathode 10, an anode 20, and a separator 30 interposed between the cathode 10 and the anode 20.

The lithium secondary battery may further include an electrolyte composition with which all or part of the cathode 10 and the separator 30 are impregnated. The cathode 10 may include a cathode active material, a binder, a conductive material, and the like.

The cathode active material may include at least one selected from the group consisting of lithium cobalt oxide, lithium nickel cobalt manganese oxide, lithium nickel cobalt aluminum oxide, lithium iron phosphorus oxide, lithium manganese oxide, and combinations thereof. However, the cathode active material is not limited thereto, and any cathode active material available in the art may be used.

The binder assists in bonding of the cathode active material and the conductive material and bonding to the current collector, and examples thereof may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, and the like.

The conductive material is not particularly limited, so long as it exhibits conductivity without causing a chemical change in the battery. Examples thereof may include graphite such as natural graphite or artificial graphite, carbon-based materials such as carbon black, acetylene black, Ketjen black, channel black, furnace black, lamp black, or thermal black, conductive fibers such as carbon fibers or metal fibers, metal powder such as carbon fluoride, aluminum, or nickel powder, conductive whiskers such as zinc oxide or potassium titanate, conductive metal oxides such as titanium oxide, conductive materials such as polyphenylene derivatives, and the like.

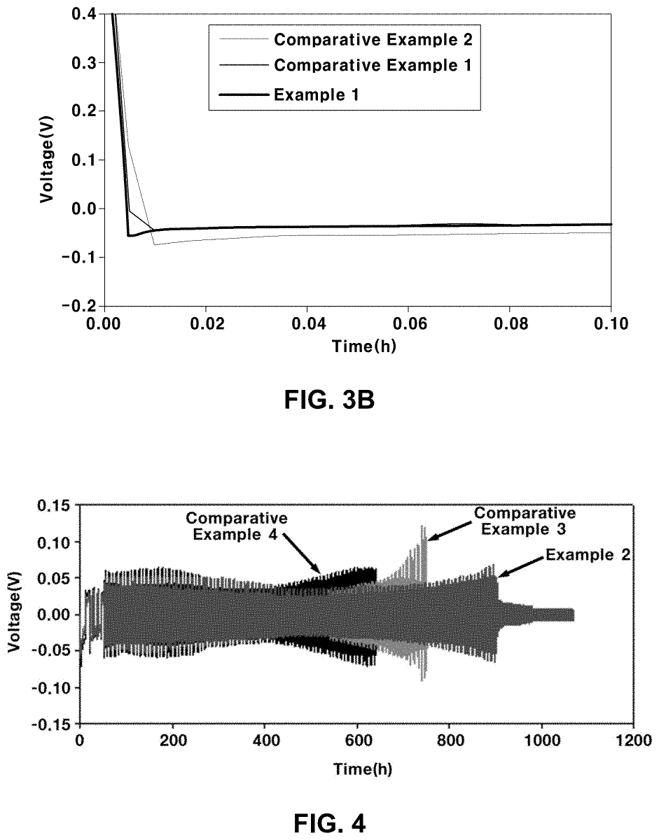

FIG. 2 shows a cross-sectional view of the anode 20. With reference thereto, the anode 20 may include a lithium electrode 21 and an SEI (solid electrolyte interphase) layer 22 disposed on the lithium electrode 21.

The lithium electrode 21 may include lithium metal or a lithium metal alloy.

The lithium metal alloy may include an alloy of lithium and a metal or metalloid capable of alloying with lithium.

The metal or metalloid capable of alloying with lithium may include Si, Sn, Al, Ge, Pb, Bi, Sb, or the like.

The lithium electrode 21 has a high capacity per unit weight of about 3,860 mAh/g, and low electrochemical potential of about −3.040 V vs. a standard hydrogen electrode, so the use thereof for an anode is expected to greatly increase the energy density of the battery.

Since the lithium electrode 21 has very high reactivity, the electrolyte is reduced and decomposed to form the SEI layer 22 on the surface of the lithium electrode 21. Here, when the SEI layer, which is non-uniform and has low ionic conductivity and mechanical strength, is formed, problems such as deterioration of stability due to non-uniform lithium plating and depletion of the electrolyte may occur.

The present disclosure pertains to an electrolyte composition capable of providing a lithium secondary battery having high specific capacity, high efficiency of utilization of lithium, and a long lifespan by forming the stable SEI layer 22 on the lithium electrode 21.

First, the SEI layer 22 is disposed on the lithium electrode 21, and may include a first layer 221 including at least one selected from the group consisting of LiF, LiₓPO_{y}F_{z} (0.1≤x≤1, 2≤y≤3, 1≤z≤2), and combinations thereof, a second layer 222 disposed on the first layer 221 and including Li₃N, and a third layer 223 disposed on the second layer 222 and including at least one selected from the group consisting of LiF, LiₓPO_{y}F_{z} (0.1≤x≤1, 2≤y≤3, 1≤z≤2), and combinations thereof.

The first layer 221 and the third layer 223 may improve the mechanical properties of the SEI layer 22. The first layer 221 and the third layer 223 may suppress the growth of lithium dendrites.

The second layer 222 may increase lithium ion conductivity of the SEI layer 22.

The electrolyte composition according to the present disclosure for forming the SEI layer is specified below.

The electrolyte composition may include a lithium salt containing a nitrogen element, a first additive having a LUMO (lowest occupied molecular orbital) value lower than the LUMO value of the lithium salt, and a second additive having a LUMO value higher than the LUMO value of the lithium salt.

The lithium salt may include a first lithium salt and a second lithium salt.

The first lithium salt is not limited, so long as it is capable of being used in a lithium secondary battery, and may include at least one selected from the group consisting of lithium bis(fluorosulfonyl)imide (LiFSI), lithium bis(trifluoromethanesulfonyl)imide (LiTFSI), LiPF₆, LiBF₄, LiSbF₆, LiAsF₆, LiN(SO₂CF₃)₂, LiN(SO₃C₂F₅)₂, LiC₄F₉SO₃, LiClO₄, LiAlO₂, LiAICl₄, LiCl, LiI, and combinations thereof. Preferably, the first lithium salt includes lithium bis(fluorosulfonyl)imide (LiFSI). The lithium bis(fluorosulfonyl)imide (LiFSI) has low binding energy, so it is easily ionized (dissociated) in an organic solvent, does not generate an acidic compound such as hydrogen fluoride (HF), and provides fluorine to the lithium electrode to thus form an inorganic film component having excellent mechanical strength, such as LiF.

The concentration of the first lithium salt may range from about 0.5 mol/L to about 3 mol/L, or about 1.0 mol/L to about 2.0 mol/L. If the concentration of the first lithium salt is less than 0.5 mol/L, a free solvent, which does not undergo ion-dipole interaction with excess lithium ions, may be generated, so side reactions may increasingly occur on the surface of the lithium electrode, and thus the electrolyte composition may become unsatisfactory, thereby increasing the battery resistance and continuously accumulating decomposition products generated by the side reactions, undesirably deteriorating the efficiency of utilization of lithium. On the other hand, if the concentration of the first lithium salt exceeds 3 mol/L, initial coulombic efficiency (ICE) may increase, but solvation with lithium ions may increase, so the viscosity of the electrolyte composition may become very high, and accordingly, the battery resistance may increase and the battery output characteristics may be deteriorated.

The second lithium salt may form the second layer 222 containing nitrogen elements in the SEI layer 22, and may include LiNO₃.

The concentration of the second lithium salt may range from about 0.1 mol/L to about 2 mol/L, or about 0.2 mol/L to about 1 mol/L. If the concentration of the second lithium salt is less than 0.1 mol/L, the second layer 222 may not be properly formed, whereas if it exceeds 2 mol/L, the second layer 222 may be excessively thickened, undesirably increasing resistance.

The second lithium salt may have a LUMO value of about −2 eV to about −1 eV. In the present disclosure, the SEI layer 22 shown in FIG. 2 is formed by selectively using specific first and second additives based on the LUMO value of the second lithium salt, which is specified below.

The first and second additives are materials that are reduced and decomposed before the organic solvent, and are reduced and decomposed to thus form a stable SEI layer 22 on the lithium electrode 21, thereby suppressing the formation of lithium dendrites.

The first additive forms the first layer 221 on the lithium electrode 21, and the second additive forms the third layer 223. The first layer 221 and the third layer 223 are positioned on both sides of the second layer 222 to thus suppress the formation of lithium dendrites.

The first additive and the second additive are classified according to the reduction potential thereof. Specifically, these additives are classified based on the LUMO value of the lithium salt, particularly the LUMO value of the minor lithium salt.

The LUMO value of the first additive may range from about −4 eV to about −3 eV. Since the first additive has a LUMO value lower than the LUMO value of the lithium salt, the reduction decomposition tendency thereof is higher than that of the lithium salt. Therefore, when the lithium secondary battery is driven, the first additive is reduced and decomposed before the lithium salt to thus form the first layer 221 on the surface of the lithium electrode 21.

The first additive may include at least one selected from the group consisting of lithium bis(oxalato)borate (LiBOB), lithium difluoro bis(oxalato)phosphate (LiDFBP), lithium fluoro(oxalate)borate (LiFOB), and combinations thereof.

The amount of the first additive may range from about 0.1 wt % to about 10 wt %, or about 0.5 wt % to about 2 wt % with respect to the electrolyte composition. If the amount of the first additive is less than 0.1 wt %, the first layer 221 may not be sufficiently formed, whereas if it exceeds 10 wt %, the first layer 221 may be excessively thickened, undesirably increasing the battery resistance.

The LUMO value of the second additive may range from about −1.5 eV to about 2 eV. Since the LUMO value of the second additive is higher than the LUMO value of the lithium salt, the reduction decomposition tendency thereof is lower than that of the lithium salt. Therefore, when the lithium secondary battery is driven, the lithium salt is reduced and decomposed before the second additive to thus form the second layer 222 on the first layer 221, and the second additive forms the third layer 223 on the second layer 222.

The second additive may include at least one selected from the group consisting of LiPF₆, LiPO₂F₂, lithium bis(trifluoromethanesulfonyl)imide (LiTFSI), and combinations thereof.

The amount of the second additive may range from about 0.1 wt % to 10 wt %, or about 0.5 wt % to 2 wt % with respect to the electrolyte composition. If the amount of the second additive is less than 0.1 wt %, the third layer 223 may not be sufficiently formed, whereas if it exceeds 10 wt %, the third layer 223 may be excessively thickened, undesirably increasing the battery resistance.

The electrolyte composition may further include an organic solvent.

The organic solvent may include at least one selected from the group consisting of dimethyl ether, 1,2-dimethoxyethane (DME), 1,3-dioxolane, diethylene glycol, tetraethylene glycol, diethylene glycol dimethyl ether, triethylene glycol dimethyl ether, tetraethylene glycol dimethyl ether, and combinations thereof. Preferably, the organic solvent includes dimethyl ether, which has excellent ability to dissociate the lithium salt and low reactivity with the lithium electrode.

In addition, the present disclosure pertains to a method of manufacturing a lithium secondary battery using the electrolyte composition described above, which is specified below.

The method of manufacturing the lithium secondary battery may include preparing a lithium ion battery including a cathode, an anode including a lithium electrode, a separator interposed between the cathode and the anode, and an electrolyte composition, and forming an SEI layer on the surface of the anode by performing a formation process on the lithium ion battery.

The SEI layer is formed by reducing and decomposing the first additive, the second lithium salt, and the second additive through the formation process. The formation process may be performed in a manner in which charging and discharging are repeated 1 to 5 times under the conditions of a current density of about 0.5 to 1 mA/cm² and a capacity per unit area of about 3 to 10 mAh/cm².

A better understanding of the present disclosure may be obtained through the following examples and comparative examples. However, these examples are merely set forth to illustrate the present disclosure, and are not to be construed as limiting the scope of the present disclosure.

### Example 1: Manufacture of LiICu Half-Cell-Type Lithium Secondary Battery

An electrolyte composition was prepared by adding 1.5 M LiFSI as a first lithium salt and 0.5 M LiNO₃ as a second lithium salt to dimethyl ether (DME) as an organic solvent and adding 1 wt % of each of LiDFBP as a first additive and LiPF₆ as a second additive thereto.

An anode was prepared by rolling a 100-μm-thick lithium electrode on a copper foil current collector, a 20-μm-thick copper foil electrode was prepared as a cathode, and a polyethylene separator was interposed therebetween to prepare a stack. A 0.8-mm-thick stainless steel disk was used as a spacer.

Manufacture of a 2032 coin-type cell was completed by injecting 40 μl of the electrolyte composition into the stack.

The cell was subjected to a formation process by performing charging and discharging once under conditions of a current density of 0.5 mA/cm² and a capacity per unit area of 5 mAh/cm² and then performing charging and discharging three times under conditions of a current density of 1.0 mA/cm² and a capacity per unit area of 5 mAh/cm², thereby forming an SEI layer on the lithium electrode.

### Comparative Example 1

A coin-type cell was manufactured in the same manner as in Example 1, with the exception that the second additive was not added when preparing the electrolyte composition.

### Comparative Example 2

A coin-type cell was manufactured in the same manner as in Example 1, with the exception that the first and second additives were not added when preparing the electrolyte composition.

### Example 2: Manufacture of Li|Li Symmetric-Cell-Type Lithium Secondary Battery

A lithium secondary battery was manufactured in the same manner as in Example 1, with the exception that an electrode, obtained by rolling a 100-μm-thick lithium electrode on a copper foil current collector, was used as the cathode instead of copper foil, and a 1.0-mm-thick stainless steel disk was used as the spacer.

### Comparative Example 3

A coin-type cell was manufactured in the same manner as in Example 2, with the exception that the second additive was not added when preparing the electrolyte composition.

### Comparative Example 4

A coin-type cell was manufactured in the same manner as in Example 2, with the exception that the first and second additives were not added when preparing the electrolyte composition.

### Test Example 1

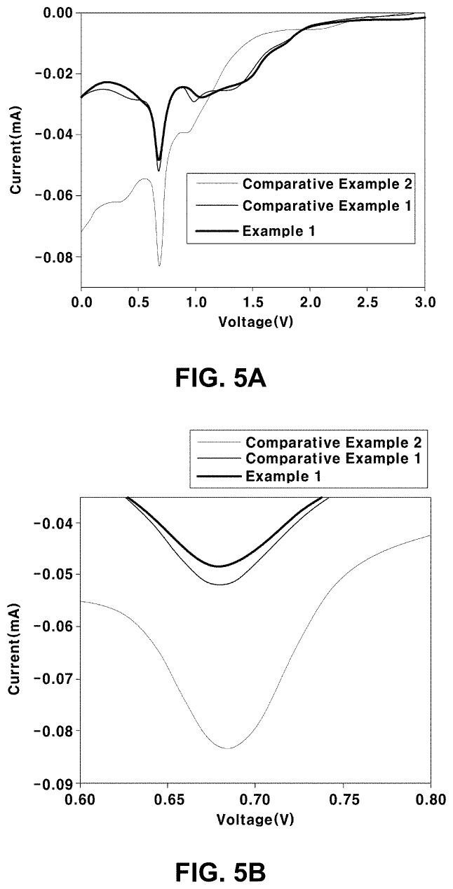

The half-cell-type lithium secondary batteries according to Example 1, Comparative Example 1, and Comparative Example 2 were charged and discharged under the conditions of a current density of 0.5 mA/cm² and a capacity per unit area of 5 mAh/cm², and the lithium plating/stripping reversibility thereof was measured. The results thereof are shown in FIGS. 3A and 3B. In addition, the efficiency of plating/stripping of lithium in each lithium secondary battery is shown in Table 1 below.

TABLE 1

| | | Efficiency of |
|---|---|---|
| | | plating/stripping |
| Classification | Features | of lithium |
| Example 1 | 1 wt % of first additive and | 96.1% |
| | 1 wt % of second additive | |
| Comparative | 1 wt % of first additive | 95.4% |
| Example 1 | | |
| Comparative | No additive | 93.8% |
| Example 2 | | |

With reference to FIGS. 3A and 3B and Table 1, the efficiency of plating/stripping of the lithium secondary battery according to Comparative Example 2 was the lowest. This is deemed to be because the organic solvent forms an unstable organic film on the surface of the lithium electrode. As is apparent from the results of Example 1, when the first additive and the second additive were used, a stable SEI layer was formed on the initial lithium electrode surface, so the efficiency of plating/stripping of lithium was increased from 93.8% to 96.1%. Moreover, when comparing Example 1 with Comparative Example 1 using the first additive alone, the efficiency thereof was found to be further increased by forming the SEI layer having a multilayer structure.

In particular, with reference to FIG. 3B, Example 1 was found to exhibit the lowest overvoltage.

### Test Example 2

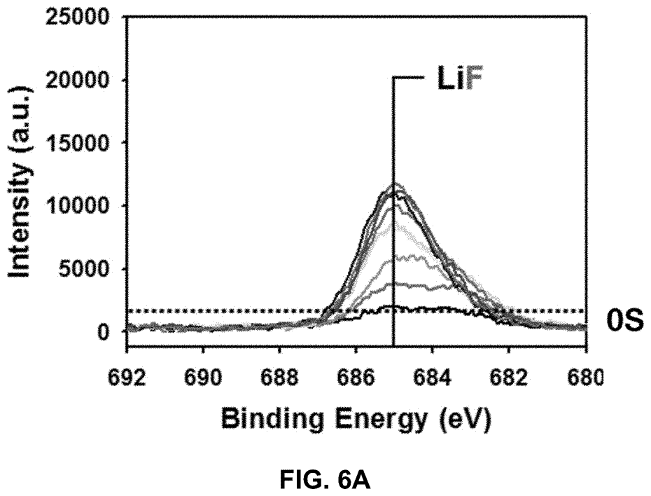

The symmetric-cell-type lithium secondary batteries according to Example 2, Comparative Example 3, and Comparative Example 4 were charged and discharged under the conditions of a current density of 0.5 mA/cm² and a capacity per unit area of 5 mAh/cm², and the lifespan thereof was evaluated. The results thereof are shown in FIG. 4 and Table 2 below.

TABLE 2

| | | Lifespan |
|---|---|---|
| | | (charge/ |
| | | discharge |
| Classification | Features | cycles) |
| Example 2 | 1 wt % of first additive and | 208 cycles |
| | 1 wt % of second additive | |
| Comparative | 1 wt % of first additive | 142 cycles |
| Example 3 | | |
| Comparative | No additive | 122 cycles |
| Example 4 | | |

With reference to FIG. 4 and Table 2, the lithium secondary battery according to Example 2 showed stable cycling within an overvoltage of 100 mV and exhibited the longest lifespan, specifically, 208 cycles.

### Test Example 3

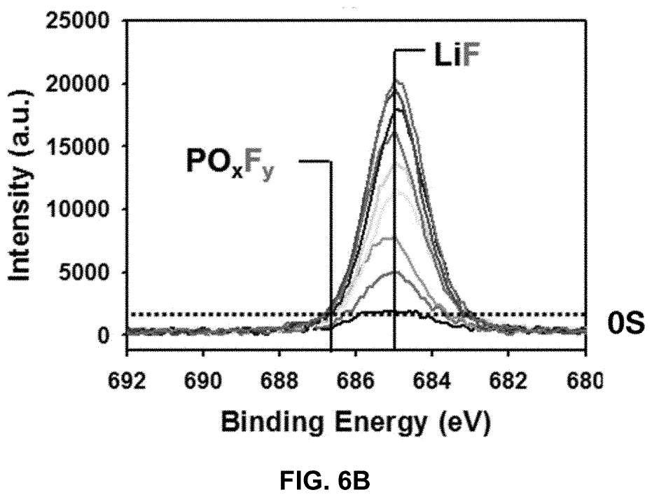

The electrochemical properties of the half-cell-type lithium secondary batteries according to Example 1, Comparative Example 1, and Comparative Example 2 were evaluated through linear sweep voltammetry (LSV). Specifically, each lithium secondary battery was measured through scanning from 0 V to OCV at a scan rate of 1 mV/sec at room temperature (25° C.). The results thereof are shown in FIGS. 5A and 5B.

With reference to FIGS. 5A and 5B, dimethyl ether as the organic solvent was decomposed at about 0.67 V, and the magnitude of the reduction peak at 0.67 V was observed to be small in Example 1 and Comparative Example 1, including the additive, compared to Comparative Example 2, not including the additive. Thus, it can be found that reduction decomposition of the organic solvent was suppressed in the lithium secondary batteries according to Example 1 and Comparative Example 1. Moreover, it can be confirmed that Example 1 including both the first additive and the second additive exhibited higher stability because reduction decomposition of the organic solvent was further suppressed.

### Test Example 4

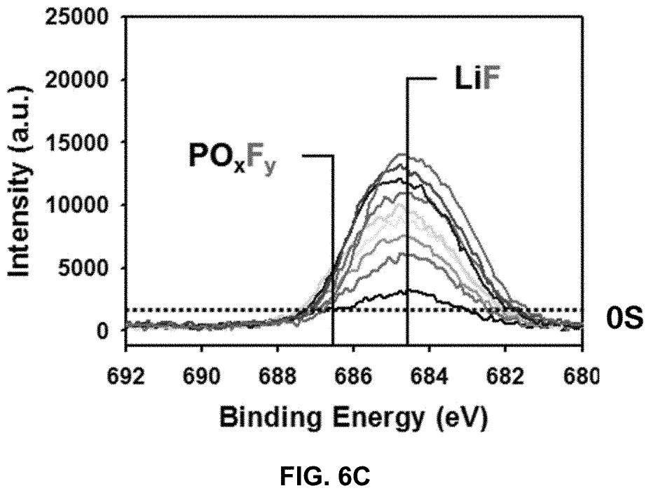

The anodes of the symmetric-cell-type lithium secondary batteries according to Example 2, Comparative Example 3, and Comparative Example 4 were analyzed through X-ray photoelectron spectroscopy (XPS). Specifically, each lithium secondary battery was charged and discharged three times under the conditions of a current density of 0.5 mA/cm² and capacity per unit area of 5 mAh/cm², and was then disassembled to obtain an anode, which was then washed with dimethyl ether, followed by F1s analysis. FIG. 6A shows the results of Comparative Example 4, FIG. 6B shows the results of Comparative Example 3, and FIG. 6C shows the results of Example 2.

With reference to FIGS. 6A and 6B, in Comparative Example 3 including the first additive, the intensity of the peak for LiF was observed to increase compared to Comparative Example 4 not including the additive, indicating that the first layer was formed in the lithium secondary battery of Comparative Example 3.

In addition, with reference to FIG. 6C, in Example 2 including the first additive and the second additive, the intensity of the peak for LiF was observed to increase even at a low depth, indicating that the third layer was also formed in the lithium secondary battery of Example 2.

Consequently, it can be confirmed that a stable SEI layer having a multilayer structure, which is the goal of the present disclosure, was formed through reduction of the first additive and the second additive in the order based on the LUMO value.

As is apparent from the above description, according to the present disclosure, an electrolyte composition capable of forming a stable SEI layer having a multilayer structure on an anode including a lithium electrode can be obtained.

The effects of the present disclosure are not limited to the above-mentioned effects. It should be understood that the effects of the present disclosure include all effects that can be inferred from the description of the present disclosure.

Although embodiments have been described hereinbefore with reference to limited examples and drawings, various modifications and variations are possible from the above description by those skilled in the art. For example, even when the techniques described are performed in a different order than the method described and/or even when the described components are coupled or combined in a form different from the described method or are replaced or substituted by other components or equivalents, appropriate results can be achieved. Therefore, other implementations, other embodiments, and equivalents to the claims are also incorporated in the scope of the following claims.

What is claimed is:

1. An electrolyte composition for a lithium secondary battery, comprising:
a lithium salt comprising a nitrogen element;
a first additive having a LUMO (lowest occupied molecular orbital) value lower than a LUMO value of the lithium salt; and
a second additive having a LUMO value higher than the LUMO value of the lithium salt.

2. The electrolyte composition of claim 1, wherein the lithium salt comprises:
a first lithium salt comprising at least one of lithium bis(fluorosulfonyl)imide (LiFSI), lithium bis(trifluoromethanesulfonyl)imide (LiTFSI), LiPF₆, LiBF₄, LiSbF₆, LiAsF₆, LiN(SO₂CF₃)₂, LiN(SO₃C₂F₅)₂, LiC₄F₉SO₃, LiClO₄, LiAlO₂, LiAICl₄, LiCl, LiI, or any combination thereof; and
a second lithium salt comprising LiNO₃.

3. The electrolyte composition of claim 2, wherein a concentration of the first lithium salt ranges from about 0.5 mol/L to about 3 mol/L.

4. The electrolyte composition of claim 2, wherein a concentration of the second lithium salt ranges from about 0.1 mol/L to about 2 mol/L.

5. The electrolyte composition of claim 1, wherein the LUMO value of the lithium salt ranges from about −2 eV to about −1 eV.

6. The electrolyte composition of claim 1, wherein the LUMO value of the first additive ranges from about −4 eV to about −3 eV.

7. The electrolyte composition of claim 1, wherein the first additive comprises at least one of lithium bis(oxalato)borate (LiBOB), lithium difluoro bis(oxalato)phosphate (LiDFBP), lithium fluoro(oxalate)borate (LiFOB), or any combination thereof.

8. The electrolyte composition of claim 1, wherein an amount of the first additive ranges from about 0.1 wt % to about 10 wt % with respect to the electrolyte composition.

9. The electrolyte composition of claim 1, wherein the LUMO value of the second additive ranges from about −1.5 eV to about 2 eV.

10. The electrolyte composition of claim 1, wherein the second additive comprises at least one of LiPF₆, LiPO₂F₂, lithium bis(trifluoromethanesulfonyl)imide (LiTFSI), or any combination thereof.

11. The electrolyte composition of claim 1, wherein an amount of the second additive ranges from about 0.1 wt % to about 10 wt % with respect to the electrolyte composition.

12. The electrolyte composition of claim 1, further comprising an organic solvent comprising at least one of dimethyl ether, 1,2-dimethoxyethane (DME), 1,3-dioxolane, diethylene glycol, tetraethylene glycol, diethylene glycol dimethyl ether, triethylene glycol dimethyl ether, tetraethylene glycol dimethyl ether, or any combination thereof.

13. An anode for a lithium secondary battery, comprising:
a lithium electrode; and
a solid electrolyte interphase (SEI) layer comprising a first layer disposed on the lithium electrode, a second layer disposed on the first layer and a third layer disposed on the second layer, wherein the first layer comprises at least one of LiF, LiₓPO_{y}F_{z} (0.1≤x≤1, 2≤y≤3, 1≤z≤2), or any combination thereof, the second layer comprises Li₃N, and the third layer comprises at least one of LiF, LiₓPO_{y}F_{z} (0.1≤x≤1, 2≤y≤3, 1≤z≤2), or any combination thereof, and
wherein the SEI layer is derived from the electrolyte composition of claim 1.

14. A method of manufacturing a lithium secondary battery, comprising:
preparing a lithium ion battery comprising a cathode, an anode comprising a lithium electrode, a separator interposed between the cathode and the anode, and the electrolyte composition of claim 1; and
forming a solid electrolyte interphase (SEI) layer on a surface of the anode by performing a formation process on the lithium ion battery,
wherein the SEI layer comprises a first layer disposed on the anode, a second layer disposed on the first layer and a third layer disposed on the second layer, and
the first layer comprises at least one of LiF, LiₓPO_{y}F_{z} (0.1≤x≤1, 2≤y≤3, 1≤z≤1), or any combination thereof, the second layer comprises Li₃N, and the third layer comprises at least one of LiF, LiₓPO_{y}F_{z} (0.1≤x≤1, 2≤y≤3, 1≤z≤2), or any combination thereof.

15. The method of claim 14, wherein the formation process is performed by repeating charging and discharging 1 to 5 times under conditions of a current density of about 0.5 to about 1 mA/cm² and a capacity per unit area of about 3 to about 10 mAh/cm².
